(19) United States
(12) Patent Application Publication
(10) Pub. No.: US 2022/0307846 A1
(43) Pub. Date: Sep. 29, 2022

(54) VEHICLE DISPATCH MANAGEMENT METHOD AND VEHICLE DISPATCH MANAGEMENT SYSTEM

(71) Applicant: PANASONIC INTELLECTUAL PROPERTY MANAGEMENT CO., LTD., Osaka (JP)

(72) Inventors: Tsuyoshi NISHIO, Chiba Ken (JP); Hwayoung KANG, Kyoto Fu (JP); Naoki USUI, Kanagawa Ken (JP)

(73) Assignee: PANASONIC INTELLECTUAL PROPERTY MANAGEMENT CO., LTD., Osaka (JP)

(21) Appl. No.: 17/590,127

(22) Filed: Feb. 1, 2022

(30) Foreign Application Priority Data
Mar. 24, 2021 (JP) 2021-050199

(51) Int. Cl. G01C 21/34; B60W 40/09; B60W 40/105

(52) U.S. Cl. CPC G01C 21/3438; B60W 40/09; B60W 40/105; B60W 2554/4049; B60W 2554/4041

(57) ABSTRACT

A vehicle dispatch management method includes: acquiring, from a requester terminal of a requester who requests vehicle dispatch, vehicle dispatch request information including requester identification information of the requester; and causing the requester terminal to display dispatched vehicle information onto a display screen of the requester terminal by outputting the dispatched vehicle information to the requester terminal. The dispatched vehicle information is information about a driver of driving characteristic information similar to passenger characteristic information. The passenger characteristic information represents driving characteristics preferred by the requester identified by the requester identification information.

### CROSS-REFERENCE TO RELATED APPLICATIONS

This application is based upon and claims the benefit of priority from Japanese Patent Application No. 2021-050199, filed on Mar. 24, 2021, the entire contents of which are incorporated herein by reference.

### FIELD

The present disclosure relates generally to a vehicle dispatch management method and a vehicle dispatch management system.

### BACKGROUND

A system for dispatching a vehicle to a requester has been known. Such a known system is constituted to, for example, determine a vehicle to be dispatched by using a location where a requester desires to dispatch a vehicle and using positions of vehicles, and then transmit a movement instruction to the vehicle (for example, Japanese Patent Application Laid-open No. 2021-022289).

However, in the related art, there has been a case that a vehicle of a driver who does not have driving characteristics preferred by the requester is dispatched. In other words, in the related art, a vehicle has not been dispatched so as to meet the requester's preference for driving.

### SUMMARY

A vehicle dispatch management method according to the present disclosure includes: acquiring, from a requester terminal of a requester who requests vehicle dispatch, vehicle dispatch request information including requester identification information of the requester; and causing the requester terminal to display dispatched vehicle information onto a display screen of the requester terminal by outputting the dispatched vehicle information to the requester terminal. The dispatched vehicle information is information about a driver of driving characteristic information similar to passenger characteristic information. The passenger characteristic information represents driving characteristics preferred by the requester identified by the requester identification information.

### BRIEF DESCRIPTION OF THE DRAWINGS

FIG. 1 is a schematic diagram of an example of a vehicle dispatch system;

FIG. 2 is a block diagram of an example of a functional configuration of a vehicle;

FIG. 3 is a block diagram of an example of a functional configuration of a requester terminal;

FIG. 4 is a schematic diagram illustrating an example of a reception screen;

FIG. 5A is a schematic diagram of an example of a display screen of dispatched vehicle information;

FIG. 5B is a schematic diagram of an example of a display screen of dispatched vehicle information;

FIG. 6 is a block diagram of an example of a functional configuration of a driving characteristic server;

FIG. 7 is a schematic diagram illustrating an example of a data configuration of a driver DB;

FIG. 8 is a schematic diagram illustrating an example of a data configuration of a requester DB;

FIG. 9 is a block diagram of an example of a functional configuration of a matching server;

FIG. 10 is a hardware configuration diagram;

FIG. 11 is a sequence diagram of an example of generation of driving characteristic information;

FIG. 12 is a sequence diagram of an example of generation of passenger characteristic information; and

FIG. 13 is a sequence diagram of an example of vehicle dispatch.

### DETAILED DESCRIPTION

Hereinafter, an embodiment of a vehicle dispatch management method and a vehicle dispatch management system according to the present disclosure will be described with reference to the accompanying drawings.

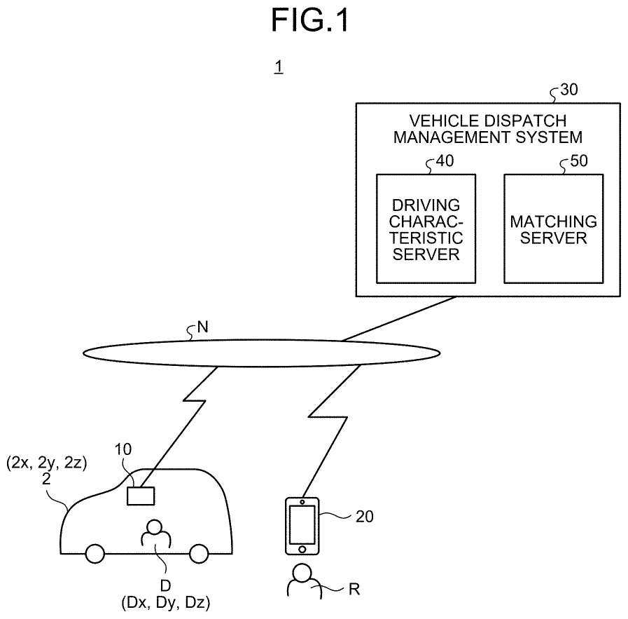

FIG. 1 is a schematic diagram of an example of a vehicle dispatch system 1 according to the present embodiment.

The vehicle dispatch system 1 is a system that dispatches a vehicle 2 to a requester R. Vehicle dispatch means allocating and sending the vehicle 2 to the requester R. The requester R is a user who requests dispatch of the vehicle 2.

The vehicle dispatch system 1 includes an in-vehicle system 10, a requester terminal 20, and a vehicle dispatch management system 30. The in-vehicle system 10, the requester terminal 20, and the vehicle dispatch management system 30 are communicably connected to each other over a network N or the like.

The in-vehicle system 10 is a system mounted on the vehicle 2. The vehicle 2 is driven by a driver D. The vehicle 2 is, for example, a two-wheeled vehicle, a three-wheeled vehicle, or a four-wheeled vehicle. In the present embodiment, a case where the vehicle 2 is a four-wheeled vehicle will be described as an example.

The requester terminal 20 is an information processing apparatus to be used or managed by the requester R.

The vehicle dispatch management system 30 is a system that manages dispatch of the vehicle 2. The vehicle dispatch management system 30 causes the requester terminal 20 to display dispatched vehicle information regarding the driver D of the vehicle 2, which is to be dispatched, on the basis of vehicle dispatch request information acquired from the requester terminal 20 of the requester R. Details of the processing will be described later.

The vehicle dispatch management system 30 includes one or more information processing apparatuses. In the present embodiment, the vehicle dispatch management system 30 includes a driving characteristic server 40 and a matching server 50. The driving characteristic server 40 and the matching server 50 are communicably connected to each other. The vehicle dispatch management system 30 and the driving characteristic server 40 are examples of the information processing apparatus.

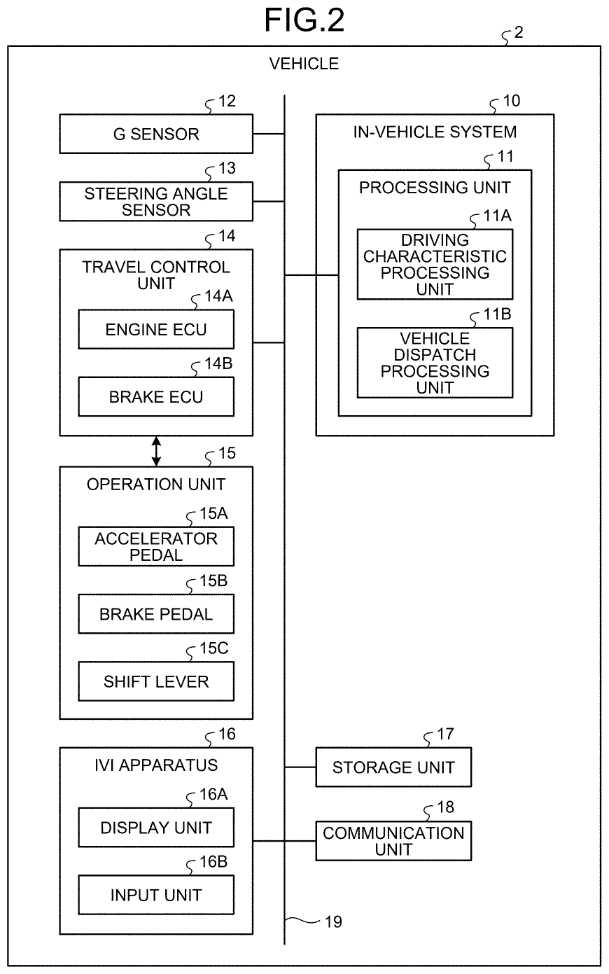

FIG. 2 is a block diagram of an example of a functional configuration of the vehicle 2. The vehicle 2 includes a G sensor 12, a steering angle sensor 13, a travel control unit 14, an operation unit 15, an in-vehicle infotainment (IVI) apparatus 16, a storage unit 17, and a communication unit 18. The G sensor 12, the steering angle sensor 13, the travel control unit 14, the operation unit 15, the IVI apparatus 16, the storage unit 17, and the communication unit 18 are communicably connected to each other over a bus 19 or the like.

The G sensor 12 measures acceleration of the vehicle 2. In the present embodiment, the G sensor 12 measures values of acceleration in a traveling direction, a direction opposite to the traveling direction of the vehicle 2, and a direction intersecting the traveling direction. The traveling direction and the direction opposite to the traveling direction match an overall length direction orthogonal to a vehicle width direction of the vehicle 2. The direction intersecting the traveling direction matches the vehicle width direction of the vehicle 2.

The steering angle sensor 13 detects a steering angle of a steering wheel provided in the vehicle 2.

The travel control unit 14 is an electric control unit (ECU) that controls traveling of the vehicle 2. The travel control unit 14 is communicably connected to the operation unit 15.

The travel control unit 14 includes an engine ECU 14A and a brake ECU 14B.

The engine ECU 14A executes control of a drive device such as an engine and a motor of the vehicle 2 and control of a transmission system device such as a transmission of the vehicle 2. The engine ECU 14A is communicably connected to the operation unit 15. The engine ECU 14A controls the drive device and the transmission system device in accordance with operation information of the operation unit 15 by the driver D received from the operation unit 15. The operation information of the operation unit 15 by the driver D is, for example, operation information as to an accelerator pedal 15A, a brake pedal 15B, a shift lever 15C, and the like. Note that the operation unit 15 mounted on the vehicle 2 is not limited thereto.

In addition, the engine ECU 14A detects, as vehicle speed, information as to wheel speed received from a wheel speed sensor provided in the vehicle 2.

The brake ECU 14B controls a braking system of the vehicle 2. For example, the brake ECU 14B controls a brake actuator that activates hydraulic brake devices disposed at wheels of the vehicle 2. The brake ECU 14B also controls a brake actuator to transmit information to the driver through driving of the brake pedal 15B.

The IVI apparatus 16 is an apparatus that provides a car navigation function, a function of position information provision service, an Internet connection function, a function of reproducing multimedia such as audio and video, and the like. The IVI apparatus 16 is provided with a display unit 16A and an input unit 16B. The display unit 16A is a display apparatus that displays various images. The input unit 16B receives an operation instruction from the user. Note that at least one of the display unit 16A and the input unit 16B may be constituted separately from the IVI apparatus 16. Further, the display unit 16A and the input unit 16B may be integrally constituted as a touch panel.

The storage unit 17 stores various kinds of data. The storage unit 17 is, for example, a random access memory (RAM), a semiconductor memory element such as a flash memory, a hard disk, an optical disk, or the like. Note that the storage unit 17 may be a storage medium. Specifically, the storage medium may store or temporarily store a program or various kinds of information downloaded over a local area network (LAN), the Internet, or the like. Furthermore, the storage unit 17 may include a plurality of storage media.

The communication unit 18 has a communication function of communicating with an external information processing apparatus over the network N or the like.

The in-vehicle system 10 is a system mounted on the vehicle 2. The in-vehicle system 10 includes a processing unit 11. The processing unit 11 executes various kinds of information processing.

The processing unit 11 includes a driving characteristic processing unit 11A and a vehicle dispatch processing unit 11B. Part of or all the driving characteristic processing unit 11A and the vehicle dispatch processing unit 11B may be implemented by causing a processing apparatus such as a central processing unit (CPU) to execute a program, that is, may be implemented by software, may be implemented by hardware such as an integrated circuit (IC), or may be implemented by using software and hardware in combination. In addition, at least one of the driving characteristic processing unit 11A and the vehicle dispatch processing unit 11B may be mounted on an external information processing apparatus which is communicably connected to the in-vehicle system 10 over the network N or the like.

The driving characteristic processing unit 11A executes processing regarding driving characteristic information of the driver D of the vehicle 2.

The driving characteristic information represents driving characteristics of the driver D. The driving characteristic information includes, for example, at least one of acceleration in a traveling direction, acceleration in a direction opposite to the traveling direction, acceleration in a direction intersecting the traveling direction, jerk, a type of a selected road, and a degree of overspeed of vehicle speed with respect to a speed limit when the vehicle 2 travels. Hereinafter, the acceleration in the traveling direction and in the direction opposite to the traveling direction may be referred to as acceleration in a forward-back direction. Further, the acceleration in the direction intersecting the traveling direction may be referred to as lateral G. The driving characteristic information only requires to be information representing the driving characteristics of the driver D and may further include other information.

The driving characteristic information is represented by, for example, at least one of driving characteristic parameters and a driving characteristic vector.

The driving characteristic parameters mean values of respective items representing driving characteristics, such as acceleration in the forward-back direction, the lateral G, jerk, a type of a selected road, and a degree of overspeed.

The driving characteristic vector is an average value of the parameters which are values of the items described above. For example, it is assumed that the number of items representing the driving characteristics is “n”. The “n” is an integer equal to or greater than 1. In this case, the driving characteristic vector is expressed with an n-th order vector.

In the present embodiment, the driving characteristic processing unit 11A acquires the driving characteristic parameters of the driver D. The driving characteristic processing unit 11A acquires the driving characteristic parameters by acquiring measurement results from the G sensor 12, the steering angle sensor 13, the travel control unit 14, and the IVI apparatus 16.

For example, the driving characteristic processing unit 11A acquires the measurement results of the acceleration and the lateral G of the vehicle 2 from the G sensor 12. In addition, the driving characteristic processing unit 11A acquires steering angle information representing a steering angle from the steering angle sensor 13. Further, the driving characteristic processing unit 11A acquires, from the travel control unit 14, pieces of operation information as to the accelerator pedal 15A, the brake pedal 15B, and the shift lever 15C, and vehicle speed. In addition, the driving characteristic processing unit 11A acquires, from the IVI apparatus 16, position information of the vehicle 2 and map information.

The driving characteristic processing unit 11A determines acceleration at the time of acceleration or deceleration on the basis of the operation information of the accelerator pedal 15A and the brake pedal 15B and a measurement result of the acceleration. Further, the driving characteristic processing unit 11A derives the jerk from the measurement result of the acceleration. In addition, the driving characteristic processing unit 11A derives, from the map information and the vehicle speed, a degree of overspeed with respect to a speed limit defined for a road on which the vehicle is traveling. Further, the driving characteristic processing unit 11A determines the lateral G measured at a specific point when the vehicle passes through an intersection or a curve, on the basis of the measurement results of the acceleration and the lateral G, the steering angle information, and the vehicle speed. Still further, the driving characteristic processing unit 11A determines a type of the road selected by the driver D by using navigation information, the map information, and the like, received from the IVI apparatus 16. For example, the driving characteristic processing unit 11A determines the type of the road such as a wide road even if it is congested and a back road which is not congested even if it is a detour.

The driving characteristic processing unit 11A acquires driver identification information of the driver D. The driver identification information is information for uniquely identifying the driver D. Hereinafter, the driver identification information may be referred to as a driver identifier (ID). The driver ID is, for example, an e-mail address of the driver D, but is not limited to the e-mail address. The storage unit 17 stores in advance the driver ID of the driver D who drives the vehicle 2. The driving characteristic processing unit 11A acquires the driver ID by reading out the driver ID from the storage unit 17.

The driving characteristic processing unit 11A transmits, to the driving characteristic server 40, the driving characteristic parameters of respective items representing the driving characteristics such as the acceleration in the forward-back direction, the lateral G, the jerk, the type of the selected road, and the degree of overspeed, and the driver ID.

The driving characteristic processing unit 11A receives, from the driving characteristic server 40, the driving characteristic vector generated by the driving characteristic server 40 on the basis of the transmitted driving characteristic parameters. The driving characteristic processing unit 11A stores the received driving characteristic vector in the storage unit 17. Specifically, the driving characteristic processing unit 11A updates the driving characteristic vector stored in the storage unit 17. The driving characteristic processing unit 11A sequentially and repeatedly executes a series of processing including acquisition of the driving characteristic parameters, transmission of the driving characteristic parameters and the driver ID to the driving characteristic server 40, and update of the driving characteristic vector received from the driving characteristic server 40. Thus, a driving characteristic vector representing the latest driving characteristics of the driver D is registered in the storage unit 17.

The driving characteristic processing unit 11A may display the updated driving characteristic vector on the display unit 16A. In addition, the driving characteristic processing unit 11A may display the driving characteristic parameters on the display unit 16A. The driver D can understand his/her driving characteristics by checking the driving characteristic information displayed on the display unit 16A.

The driving characteristic processing unit 11A may display a quick response (QR) code (registered trademark) representing the driver ID and the driving characteristic vector on the display unit 16A. In this case, the driver D can check the driving characteristic vector expressed by the QR code by reading the QR code (registered trademark) with a mobile terminal or the like. The mobile terminal that reads the QR code may be an information processing apparatus which can read the QR code and display the driving characteristic vector expressed by the QR code on a display, or the like. The mobile terminal is, for example, a smartphone, a tablet terminal, or the like.

In addition, the driving characteristic processing unit 11A may display at least the QR code representing the driver ID on the display unit 16A. When, for example, a display instruction signal is received from the requester terminal 20, the driving characteristic processing unit 11A displays at least the QR code representing the driver ID on the display unit 16A. The driving characteristic processing unit 11A may display the QR code representing the driver ID and the driving characteristic vector on the display unit 16A.

The driving characteristic processing unit 11A is only required to display the driver ID or the driver ID and the driving characteristic vector on the display unit 16A in a form that can be read by the requester terminal 20. Thus, a display form of the driver ID or the driver ID and the driving characteristic vector are not limited to the QR codes.

The vehicle dispatch processing unit 11B executes processing regarding dispatch of the vehicle 2. The vehicle dispatch processing unit 11B receives, from the matching server 50, a dispatch inquiry notification that is a notification of an inquiry as to whether or not a vehicle can be dispatched. The dispatch inquiry notification is a signal for inquiring the driver D as to whether or not he/she can dispatch a vehicle. The dispatch inquiry notification includes, for example, information on a desired date and time for vehicle dispatch, information on a desired location for vehicle dispatch, and the like. The information on desired date and time for vehicle dispatch is information representing date and time at which the requester R desires vehicle dispatch. The information on a desired location for vehicle dispatch is information indicating a location where the requester R desires vehicle dispatch.

The vehicle dispatch processing unit 11B displays the received dispatch inquiry notification on the display unit 16A. The driver D determines whether or not he/she can dispatch a vehicle while referring to the dispatch inquiry notification, and inputs the determination result through the display unit 16A. For example, it is assumed that driver D inputs information representing that he/she can dispatch a vehicle by operating the input unit 16B. In this case, the vehicle dispatch processing unit 11B transmits, to the matching server 50, dispatch available information including the driver ID, the determination result representing that a vehicle can be dispatched, and the position information of the vehicle 2.

It is assumed that the vehicle 2 of the driver D is specified as the vehicle 2 to be dispatched by the vehicle dispatch management system 30. In this case, the driving characteristic processing unit 11A receives vehicle dispatch request information from the matching server 50 of the vehicle dispatch management system 30. The vehicle dispatch request information includes, for example, information representing that the vehicle has been determined as a vehicle to be dispatched, the information as to the desired location for vehicle dispatch, and the information as to desired date and time for vehicle dispatch. The vehicle dispatch processing unit 11B displays the vehicle dispatch request information on the display unit 16A. By checking the vehicle dispatch request information displayed on the display unit 16A, the driver D can understand that his/her vehicle is specified as the vehicle 2 to be dispatched and information regarding date and time and the location for vehicle dispatch.

Next, the requester terminal 20 will be described.

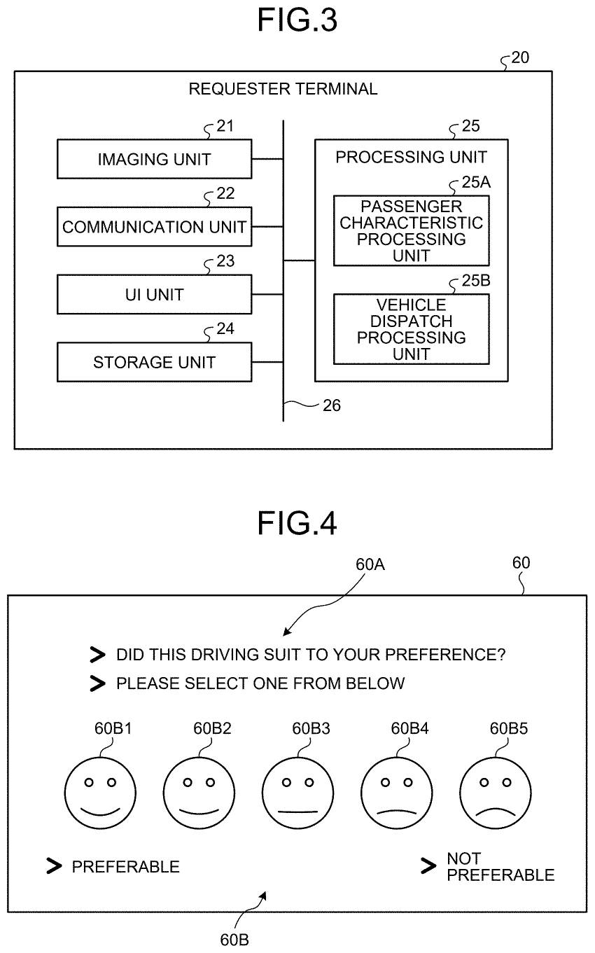

FIG. 3 is a block diagram of an example of a functional configuration of the requester terminal 20. The requester terminal 20 is an information processing apparatus to be used or managed by the requester R who requests vehicle dispatch. The requester terminal 20 is, for example, a smartphone, a tablet terminal, or the like.

The requester terminal 20 includes an imaging unit 21, a communication unit 22, a user interface (UI) unit 23, a storage unit 24, and a processing unit 25. The imaging unit 21, the communication unit 22, the UI unit 23, the storage unit 24, and the processing unit 25 are communicably connected to each other over a bus 26 or the like.

The imaging unit 21 obtains a captured image by imaging. In the present embodiment, the imaging unit 21 is used when the requester R who rides in the vehicle 2 of the driver D captures an image of the QR code displayed on the display unit 16A of the vehicle 2.

The communication unit 22 has a communication function of communicating with an external information processing apparatus over the network N or the like.

The UI unit 23 includes a display function for displaying various kinds of information and an input function for receiving an operation input by the requester R. The display function is, for example, a display such as a liquid crystal display or an organic electro luminescence (EL) display. The input function is a keyboard, a pointing device such as a mouse or a pen tablet. The UI unit 23 may be a touch panel in which the display function and the input function are integrally constituted.

The storage unit 24 stores various kinds of data. The storage unit 24 includes, for example, a semiconductor memory element such as a RAM or a flash memory. The storage unit 24 may also be a storage medium. Furthermore, the storage unit 24 may include a plurality of storage media.

The processing unit 25 executes various kinds of information processing. The processing unit 25 includes a passenger characteristic processing unit 25A and a vehicle dispatch processing unit 25B. Part of or all the passenger characteristic processing unit 25A and the vehicle dispatch processing unit 25B may be implemented by causing a processing apparatus such as a CPU to execute a program, that is, may be implemented by software, may be implemented by hardware such as an IC, or may be implemented by using software and hardware in combination. In addition, at least one of the passenger characteristic processing unit 25A and the vehicle dispatch processing unit 25B may be mounted on an external information processing apparatus which is communicably connected to the requester terminal 20 over the network N or the like.

The passenger characteristic processing unit 25A executes processing regarding passenger characteristic information of the requester R who uses the requester terminal 20.

The passenger characteristic information is information representing driving characteristics preferred by the requester R. The passenger characteristic information includes, for example, at least one of acceleration in the forward-back direction, the lateral G, the jerk, the type of the selected road, and the degree of overspeed of the vehicle speed with respect to the speed limit when the vehicle 2 travels. Note that the passenger characteristic information is only required to represent the driving characteristics preferred by the requester R, but may also include other information.

Similarly to the driving characteristic information, the passenger characteristic information is represented by at least one of the driving characteristic parameters and the driving characteristic vector. In the present embodiment, the passenger characteristic information is generated in accordance with a degree of preference of the driving characteristics of the driver D of the vehicle 2 in which the requester R rides.

Specifically, the passenger characteristic processing unit 25A acquires the driving characteristic information of the driver D of the vehicle 2 from the vehicle 2 in which the requester R rides. Specifically, the passenger characteristic processing unit 25A transmits a display instruction signal of the driving characteristics to the in-vehicle system 10 of the vehicle 2. As described above, the driving characteristic processing unit 11A of the in-vehicle system 10 which has received the display instruction signal displays at least the QR code representing the driver ID on the display unit 16A.

The passenger characteristic processing unit 25A acquires the driver ID represented by the QR code by analyzing the QR code captured by the imaging unit 21. In a case where the QR code represents the driver ID and the driving characteristic vector of the driver D, the passenger characteristic processing unit 25A analyzes the QR code to acquire the driver ID and the driving characteristic vector represented by the QR code. Known analysis processing can be used to analyze the QR code.

The passenger characteristic processing unit 25A, which has read the QR code by transmitting the display instruction signal, displays a reception screen on the UI unit 23.

FIG. 4 is a schematic diagram illustrating an example of a reception screen 60. The reception screen 60 is a screen for receiving an input of a degree of preference of the requester R with respect to the driving characteristics of the driver D of the vehicle 2.

The reception screen 60 includes, for example, a selection image 60B of a degree of preference and a message 60A which encourages input of the degree of preference. FIG. 4 illustrates five stages of selection images of a selection image 60B1 to a selection image 60B5 as the selection image 60B of the degree of preference. The requester R inputs the degree of preference with respect to the driving characteristics by selecting any of the selection images 60B as the degree of preference with respect to the driving characteristics of the driver D of the vehicle 2 in which the requester R rides.

Note that the reception screen 60 may be any screen as long as it accepts input of the degree of preference of the requester R with respect to the driving characteristics of the driver D, and is not limited to the form including the plurality of selection images 60B1 to 60B5. For example, the reception screen 60 may include an input field for allowing input of the degree of preference of the requester R with a numerical value or a character, a gauge for allowing input of the degree of preference of the requester R, and the like. Further, in FIG. 4, as the selection image 60B of the degree of preference, five stages of the selection images 60B1 to 60B5 are illustrated as an example. However, the selection stage of the degree of preference is not limited to five stages, and may be two to four stages, or six or more stages. For example, the reception screen 60 may be a screen which allows selection of the degree of preference from two levels of “like” and “dislike”.

By the requester R operating the UI unit 23, the degree of preference with respect to the driving characteristics of the driver D of the vehicle 2, in which the requester R rides, is input via the reception screen 60. The passenger characteristic processing unit 25A receives preference information representing the degree of preference input by the requester R.

Returning to FIG. 3, the description will be continued. The passenger characteristic processing unit 25A acquires requester identification information of the requester R. The requester identification information is information for uniquely identifying the requester R. Hereinafter, the requester identification information may be referred to as a requester ID. The requester ID is, for example, an e-mail address of the requester R, but is not limited to the e-mail address. For example, the storage unit 24 stores in advance the requester ID of the requester R who uses the requester terminal 20. The passenger characteristic processing unit 25A acquires the requester ID by reading out the requester ID from the storage unit 24.

The passenger characteristic processing unit 25A transmits the received preference information, the driver ID, and a requester ID of the requester R to the driving characteristic server 40. The passenger characteristic processing unit 25A transmits the driver ID analyzed from the QR code displayed on the UI unit 23 to the driving characteristic server 40 together with the preference information and the requester ID. The driving characteristic server 40 generates the passenger characteristic information of the requester R identified by the requester ID using the preference information, the driver ID, and the requester ID acquired from the requester terminal 20 (details will be described later).

Next, the vehicle dispatch processing unit 25B will be described. The vehicle dispatch processing unit 25B executes processing related to dispatch of the vehicle 2.

The vehicle dispatch processing unit 25B receives an input of vehicle dispatch request information from the requester R. The requester R inputs the vehicle dispatch request information by operating the UI unit 23.

The vehicle dispatch request information is information transmitted from the requester terminal 20 to the matching server 50 when the requester R requests dispatch of the vehicle 2. The vehicle dispatch request information includes at least the requester ID of the requester R. In the present embodiment, it is assumed that the vehicle dispatch request information includes the requester ID, information as to a desired date and time for vehicle dispatch, and information as to a desired location for vehicle dispatch.

The information as to a desired date and time for vehicle dispatch is information representing a date and a time at which the requester R desires vehicle dispatch. The information as to the desired location for vehicle dispatch is information representing a desired location for vehicle dispatch where the requester R desires vehicle dispatch.

The vehicle dispatch processing unit 25B transmits the received vehicle dispatch request information to the matching server 50. The matching server 50 determines one or more vehicles 2 in accordance with the preference for driving of the requester R as a vehicle which is a candidate for vehicle dispatch on the basis of the vehicle dispatch request information and transmits display instruction information of the dispatched vehicle information to the requester terminal 20. Details of the processing of the matching server 50 will be described later.

The vehicle dispatch processing unit 25B displays the dispatched vehicle information on the UI unit 23 on the basis of the display instruction information of the dispatched vehicle information received from vehicle dispatch management system 30. In other words, the vehicle dispatch processing unit 25B of the requester terminal 20 displays the dispatched vehicle information on the UI unit 23 under the control of the vehicle dispatch management system 30.

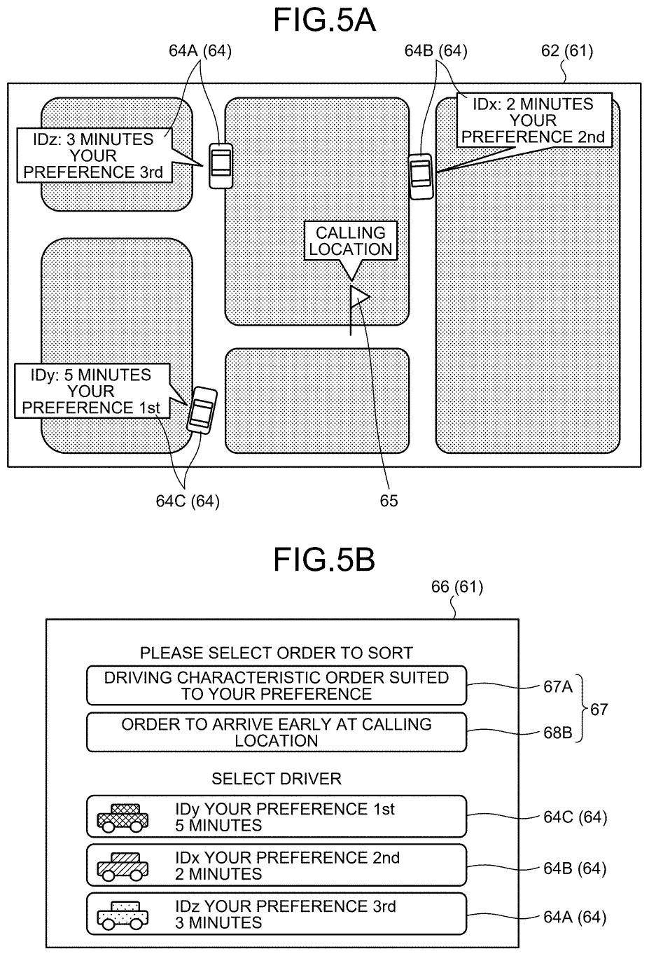

FIG. 5A is a schematic diagram of an example of a display screen 61 of dispatched vehicle information 64. FIG. 5A illustrates a display screen 62 on which the dispatched vehicle information 64 is arranged on a map image as an example of the display screen 61.

The dispatched vehicle information 64 is information regarding the driver D of the driving characteristic information similar to the passenger characteristic information representing the driving characteristics preferred by the requester R. For example, the dispatched vehicle information 64 includes at least one of the driver ID of the driver D having the driving characteristics, similarity information, and estimated time information.

The similarity information is information representing similarity of the driving characteristic information of the driver D with respect to the passenger characteristic information of the requester R. The similarity is represented by, for example, a number assigned in ascending order of the similarity, a numerical value representing a ratio of the similarity, or the like. The estimated time information is information representing time required for the vehicle 2 of the driver D to reach the desired location for vehicle dispatch.

Further, the dispatched vehicle information 64 may further include position information indicating a position of the vehicle 2 of the driver D identified by the driver ID. The position information may be position information represented by an absolute position or position information represented by a relative position with respect to the desired location for vehicle dispatch. In a case of the absolute position, the position information is expressed with, for example, latitude and longitude. The vehicle dispatch processing unit 25B may further acquire the information as to the desired location for vehicle dispatch from the matching server 50.

FIG. 5A illustrates, as the dispatched vehicle information 64, dispatched vehicle information 64A, dispatched vehicle information 64B, and dispatched vehicle information 64C. The dispatched vehicle information 64 is the dispatched vehicle information 64 of respective drivers D different from each other. FIG. 5A illustrates an example where icon images indicating the vehicles 2 and character information representing the dispatched vehicle information 64 are arranged on a map image. The icon images indicating the vehicles 2 are arranged, for example, at positions corresponding to the position information of the vehicles 2.

In FIG. 5A, IDz, IDx, and IDy are respectively examples of driver IDs of different drivers D. Specifically, IDz is a driver ID of a driver Dz. IDx is a driver ID of a driver Dx. IDy is a driver ID of a driver Dy. The driver Dz, the driver Dx, and the driver Dy are drivers D of different vehicles 2. For example, as illustrated in FIG. 1, a vehicle 2x is driven by the driver Dx, a vehicle 2y is driven by the driver Dy, and a vehicle 2z is driven by the driver Dz. The vehicle 2x, the vehicle 2y, and the vehicle 2z are examples of the vehicle 2.

Three minutes, two minutes, and five minutes illustrated in FIG. 5A are examples of the estimated time information. Your preference 3rd, your preference 2nd, and your preference 1st illustrated in FIG. 5A are examples of the similarity information.

On the display screen 62, the character information representing the dispatched vehicle information 64 is arranged in the vicinity of the icon images of the vehicles 2 arranged at the position represented by the position information of the vehicles 2 included in the dispatched vehicle information 64. In addition, the display screen 62 includes an image 65 representing a location expressed by the information as to the desired location for vehicle dispatch.

The vehicle dispatch processing unit 25B displays the display screen 62 of the dispatched vehicle information 64 on the UI unit 23 under the control of the vehicle dispatch management system 30.

FIG. 5B is a schematic diagram of an example of a display screen 61 of dispatched vehicle information 64. FIG. 5B illustrates a display screen 66 on which the dispatched vehicle information 64 is displayed in a list as an example of the display screen 61.

The display screen 66 includes a selection button 67 and pieces of the dispatched vehicle information 64. In a similar manner to FIG. 5A, FIG. 5B illustrates the dispatched vehicle information 64A, the dispatched vehicle information 64B, and the dispatched vehicle information 64C.

The selection button 67 is a button image for receiving selection of rearrangement. The selection button 67 includes, for example, a selection button 67A and a selection button 67B. The selection button 67A is a selection button 67 for instructing rearrangement of the dispatched vehicle information 64 in order of the similarity. The order of the similarity is descending order of the similarity or ascending order of the similarity. The selection button 67B is a selection button 67 for instructing rearrangement of the dispatched vehicle information 64 in order of the required time. The order of the required time is ascending order of the required time or descending order of the required time.

It is assumed that the requester R selects the selection button 67A by operating the UI unit 23. In this case, for example, the vehicle dispatch processing unit 25B arranges and displays the dispatched vehicle information 64A, the dispatched vehicle information 64B, and the dispatched vehicle information 64C displayed on the display screen 66 in descending order of the similarity. In addition, it is assumed that the requester R selects the selection button 67B by operating the UI unit 23. In this case, for example, the vehicle dispatch processing unit 25B arranges and displays the dispatched vehicle information 64A, the dispatched vehicle information 64B, and the dispatched vehicle information 64C displayed on the display screen 66 in ascending order of the required time.

The vehicle dispatch processing unit 25B displays the display screen 61 of the dispatched vehicle information 64 such as the display screen 62 illustrated in FIG. 5A or the display screen 66 illustrated in FIG. 5B on the UI unit 23 under the control of the vehicle dispatch management system 30.

The requester R selects the dispatched vehicle information 64 of the driver D who desires to dispatch the vehicle by operating the UI unit 23 while referring to the displayed display screen 61. The vehicle dispatch processing unit 25B transmits the driver ID included in the selected dispatched vehicle information 64 to the matching server 50.

Thus, the requester R can easily check a list of the dispatched vehicle information 64 of the driver D having driving characteristics preferred by the requester R by checking the dispatched vehicle information 64 on the display screen 61 displayed on the UI unit 23. In addition, the requester R can select the dispatched vehicle information 64 of the driver D who desires to dispatch the vehicle from a list of the dispatched vehicle information 64 of the driver D having driving characteristics preferred by the requester R displayed on the UI unit 23.

Further, the dispatched vehicle information 64 includes the similarity information. Thus, the requester R can select the desired dispatched vehicle information 64 in consideration of the similarity with respect to the driving characteristics preferred by the requester R.

Further, the dispatched vehicle information 64 includes the estimated time information of the required time. Thus, the requester R can select the desired dispatched vehicle information 64 in consideration of the similarity with respect to the driving characteristics preferred by the requester R and the time required for the vehicle 2 to reach the desired location for vehicle dispatch.

Returning to FIG. 1, the description will be continued. Next, the vehicle dispatch management system 30 will be described. As described above, the vehicle dispatch management system 30 is a system that manages dispatch of the vehicle 2 to the requester R. The vehicle dispatch management system 30 causes the UI unit 23 of the requester terminal 20 to display, on the display screen 61, the dispatched vehicle information 64 regarding the driver D having the driving characteristic information similar to the passenger characteristic information of the requester R, on the basis of the vehicle dispatch request information acquired from the requester terminal 20 of the requester R.

The driving characteristic server 40 included in the vehicle dispatch management system 30 will be described.

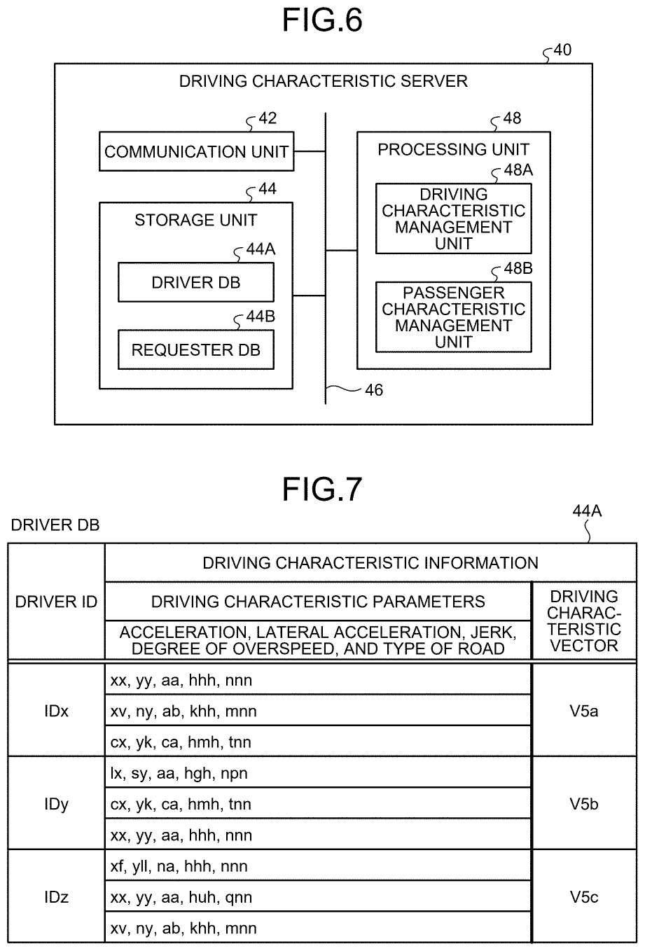

FIG. 6 is a block diagram of an example of a functional configuration of the driving characteristic server 40. The driving characteristic server 40 is an information processing apparatus for managing the driving characteristic information of the driver D and the passenger characteristic information of the requester R.

The driving characteristic server 40 includes a communication unit 42, a storage unit 44, and a processing unit 48. The communication unit 42, the storage unit 44, and the processing unit 48 are communicably connected to each other over a bus 46 or the like.

The communication unit 42 has a communication function of communicating with an external information processing apparatus over the network N or the like.

The storage unit 44 stores various kinds of data. The storage unit 44 is, for example, a semiconductor memory element such as a RAM or a flash memory. The storage unit 44 may also be a storage medium. Furthermore, the storage unit 44 may include a plurality of storage media.

In the present embodiment, the storage unit 44 stores a driver DB 44A and a requester DB 44B. Details of the driver DB 44A and the requester DB 44B will be described later.

The processing unit 48 executes various kinds of information processing. The processing unit 48 includes a driving characteristic management unit 48A and a passenger characteristic management unit 48B. Part of or all the driving characteristic management unit 48A and the passenger characteristic management unit 48B may be implemented by causing a processing apparatus such as a CPU to execute a program, that is, may be implemented by software, may be implemented by hardware such as an IC, or may be implemented by using software and hardware in combination. In addition, at least one of the driving characteristic management unit 48A and the passenger characteristic management unit 48B may be mounted on an external information processing apparatus which is communicably connected to the driving characteristic server 40 over the network N or the like.

The driving characteristic management unit 48A manages the driving characteristic information of the driver D. The driving characteristic management unit 48A acquires the driver ID and the driving characteristic parameters from the in-vehicle system 10. As described above, the in-vehicle system 10 mounted on the vehicle 2 sequentially acquires the driving characteristic parameters of the driver D of the vehicle 2 and transmits the driving characteristic parameters to the driving characteristic server 40 together with the driver ID of the driver D. The driving characteristic server 40 acquires the driver ID and the driving characteristic parameters from the in-vehicle system 10.

The driving characteristic management unit 48A registers the acquired driving characteristic parameters in the driver DB 44A.

FIG. 7 is a schematic diagram illustrating an example of a data configuration of the driver DB 44A. The driver DB 44A is a database in which driver IDs and driving characteristic information are associated with each other. The data format of the driver DB 44A is not limited to the database. In the present embodiment, the driver DB 44A includes driving characteristic parameters and driving characteristic vectors as driving characteristic information.

The driving characteristic management unit 48A registers the driver ID and the driving characteristic parameters acquired from the in-vehicle system 10 in the driver DB 44A in association with each other. For example, the driving characteristic management unit 48A registers the driving characteristic parameters corresponding to the latest M times in the driver DB 44A. The driving characteristic parameters corresponding to the latest M times mean driving characteristic parameters acquired in the latest M times among the driving characteristic parameters acquired in the past from the in-vehicle system 10. M is an integer equal to or greater than 2. FIG. 7 illustrates, as an example, a mode in which the driving characteristic parameters corresponding to three times are registered.

The driving characteristic management unit 48A specifies one or more driving characteristic parameters registered in the past corresponding to the newly acquired driving characteristic parameters and the driver ID acquired together with the driving characteristic parameters. Then, the driving characteristic management unit 48A averages values for each of items by using these driving characteristic parameters corresponding to multiple times. As described above, the items are items representing driving characteristics such as acceleration in the forward-back direction, the lateral G, the jerk, the type of the selected road, and the degree of overspeed. Then, the driving characteristic management unit 48A generates a driving characteristic vector representing an average value for each item. The average value may be a value obtained by indexing a difference between the value for each item and the average value calculated for each item. The indexed value is, for example, a deviation value, a value expressed in three or five stages, or the like.

As described above, the driving characteristic vector is an average value of parameters that are respective values of “n” items and is expressed with an n-th order vector. Thus, the driving characteristic vector represents the driving characteristics for each driver D identified by the driver ID as an average value of the respective parameters of then items.

The driving characteristic management unit 48A registers the generated driving characteristic vector in the driver DB 44A in association with the driver ID of the driving characteristic parameters used for generating the driving characteristic vector.

Thus, the driving characteristic vector corresponding to the driver ID in the driver DB 44A is updated every time that new driving characteristic parameters are acquired from the in-vehicle system 10.

The driving characteristic management unit 48A transmits a receipt acknowledgement notification including the generated driving characteristic vector to the in-vehicle system 10 of the driver D identified by the driver ID received together with the driving characteristic parameters used for generating the driving characteristic vector. Thus, the driving characteristic management unit 48A can transmit the updated latest driving characteristic parameters to the in-vehicle system 10.

Returning to FIG. 6, the description will be continued. Next, the passenger characteristic management unit 48B will be described.

The passenger characteristic management unit 48B manages the passenger characteristic information representing the driving characteristics of the requester R. The passenger characteristic management unit 48B acquires the driver ID, the preference information, and the requester ID from the requester terminal 20 of the requester R. As described above, the requester R operates the requester terminal 20 to input the preference information representing a degree of preference for the driving characteristics of the driver D of the vehicle 2 in which the requester R rides. Then, the requester terminal 20 transmits the requester ID, the preference information, and the driver ID of the driver D to the driving characteristic server 40. The passenger characteristic management unit 48B of the driving characteristic server 40 acquires the requester ID, the preference information, and the driver ID.

The passenger characteristic management unit 48B generates passenger characteristic information using the driver DB 44A and the requester DB 44B and registers the passenger characteristic information in the requester DB 44B.

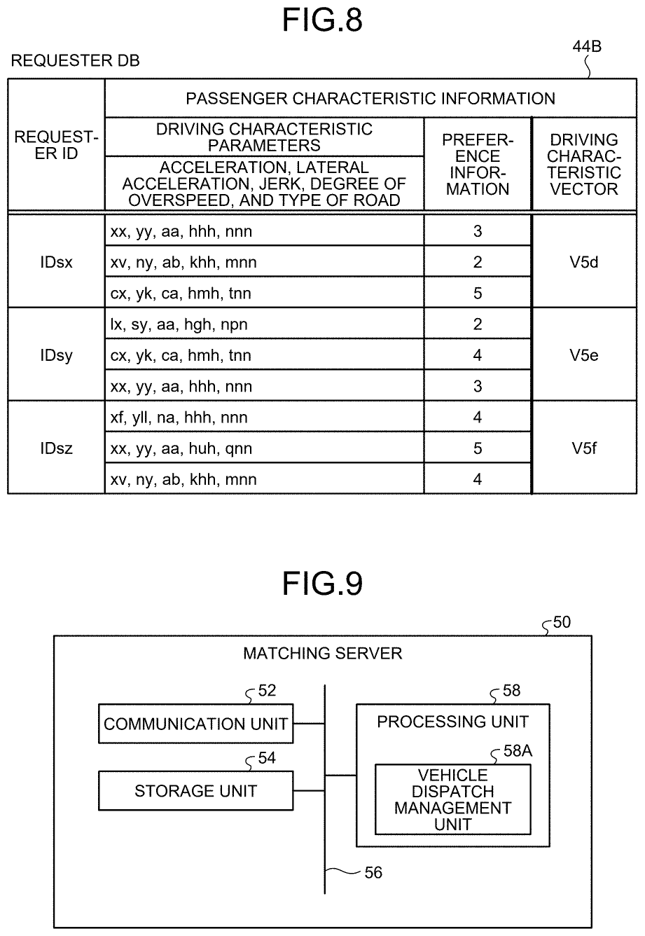

FIG. 8 is a schematic diagram illustrating an example of a data configuration of the requester DB 44B.

The requester DB 44B is a database in which the requester IDs and the passenger characteristic information are associated with each other. The data format of the requester DB 44B is not limited to the database. In the present embodiment, the requester DB 44B includes driving characteristic parameters, the preference information, and driving characteristic vectors as passenger characteristic information.

The passenger characteristic management unit 48B registers the preference information and driving characteristic parameters corresponding to the acquired driver ID in the requester DB 44B in association with the requester ID acquired from the requester terminal 20.

In the present embodiment, the driving characteristic parameters and the preference information corresponding to the latest N times are registered in the requester DB 44B for each requester ID. The preference information corresponding to the latest N times mean the preference information acquired in the latest N times among the preference information acquired in the past from the requester terminal 20. N is an integer equal to or greater than 2. FIG. 8 illustrates, as an example, a mode in which the driving characteristic parameters and the preference information corresponding to three times are registered.

The passenger characteristic management unit 48B generates the passenger characteristic information by correcting the driving characteristic information of the driver D of the vehicle 2, in which the requester R rides, with the preference information of the requester R for the driving characteristics of the driving characteristic information.

Specifically, the passenger characteristic management unit 48B specifies the driving characteristic vector corresponding to the acquired driver ID from the driver DB 44A. Then, the passenger characteristic management unit 48B generates the corrected driving characteristic vector by multiplying the specified driving characteristic vector by the acquired preference information. It is assumed that the preference information is expressed with a ratio of preference for the driving characteristic information of the driver D. For example, it is assumed that “0” is set as a value of the preference information for a case where the driving characteristics are not at all preferred, and “1” is set for a case where the driving characteristics are most preferred. Then, the value becomes greater in accordance with increase in preference for the driving characteristics.

The passenger characteristic management unit 48B multiplies respective items included in the driving characteristic parameters corresponding to respective pieces of the preference information acquired in the past M times corresponding to the acquired requester ID, by the corresponding preference information. Then, the passenger characteristic management unit 48B averages values for each item using the corrected driving characteristic vector and each driving characteristic vector obtained by multiplying the driving characteristic parameters acquired in the past by the preference information.

Then, the passenger characteristic management unit 48B generates a driving characteristic vector representing an average value for each item as passenger characteristic information of the requester R, and registers the driving characteristic vector in the requester DB 44B in association with the requester ID.

Thus, in the requester DB 44B, the passenger characteristic information obtained by correcting the driving characteristic information of the driver D of the vehicle 2 in which the requester R rides with the preference information representing a degree of preference of the requester R for the driving characteristics of the driver D is registered. Further, the driving characteristic vector that is the passenger characteristic information corresponding to the requester ID in the requester DB 44B is updated every time that new preference information is acquired from the requester terminal 20.

Next, the matching server 50 will be described.

FIG. 9 is a block diagram of an example of a functional configuration of the matching server 50. The matching server 50 is an information processing apparatus for dispatching the vehicle 2 of the driver D having the driving characteristics preferred by the requester R.

The matching server 50 includes a communication unit 52, a storage unit 54, and a processing unit 58. The communication unit 52, the storage unit 54, and the processing unit 58 are communicably connected to each other over a bus 56 or the like.

The communication unit 52 has a communication function of communicating with an external information processing apparatus over the network N or the like.

The storage unit 54 stores various kinds of data. The storage unit 54 includes, for example, a semiconductor memory element such as a RAM or a flash memory. The storage unit 54 may also be a storage medium. Furthermore, the storage unit 54 may include a plurality of storage media.

The processing unit 58 executes various kinds of information processing. The processing unit 58 includes a vehicle dispatch management unit 58A. Part of or all the vehicle dispatch management unit 58A may be implemented by causing a processing apparatus such as a CPU to execute a program, that is, may be implemented by software, may be implemented by hardware such as an IC, or may be implemented by using software and hardware in combination. In addition, the vehicle dispatch management unit 58A may be mounted on an external information processing apparatus which is communicably connected to the matching server 50 over the network N or the like.

The vehicle dispatch management unit 58A manages dispatch of the vehicle 2 to the requester R.

The vehicle dispatch management unit 58A acquires vehicle dispatch request information from the requester terminal 20. As described above, the vehicle dispatch request information includes the requester ID, the information as to the desired date and time for vehicle dispatch, and the information as to the desired location for vehicle dispatch.

Upon acquiring the vehicle dispatch request information, the vehicle dispatch management unit 58A transmits the dispatch inquiry notification to the in-vehicle system 10 of the driver D identified by the driver ID registered in the driver DB 44A. The vehicle dispatch management unit 58A acquires, from the in-vehicle system 10, dispatch the available information including a driver ID, a determination result indicating that a vehicle can be dispatched, and position information of the vehicle 2.

The vehicle dispatch management unit 58A transmits the notification of the inquiry to the driving characteristic server 40. The notification of the inquiry is a signal including a driver ID, a requester ID and information representing a request for a driving characteristic vector. The requester ID included in the notification of the inquiry is the requester ID included in the vehicle dispatch request information.

The driver ID included in the notification of the inquiry is a driver ID of the driver D of the in-vehicle system 10 that is a transmission source of the determination result representing that a vehicle can be dispatched. Thus, in a case where the determination result representing that a vehicle can be dispatched is acquired from the in-vehicle systems 10 of the plurality of drivers D, the vehicle dispatch management unit 58A transmits a notification of an inquiry including the plurality of driver IDs to the driving characteristic server 40. In the present embodiment, a mode in which a notification of an inquiry including a plurality of driver IDs is transmitted to the driving characteristic server 40 will be described as an example.

By transmitting the notification of the inquiry, the vehicle dispatch management unit 58A acquires, from the driving characteristic server 40, driving characteristic vectors that are driving characteristic information corresponding to the plurality of driver IDs, and a driving characteristic vector that is passenger characteristic information corresponding to the requester ID.

The vehicle dispatch management unit 58A calculates similarity of each of pieces of acquired driving characteristic information with respect to the acquired passenger characteristic information. Specifically, the vehicle dispatch management unit 58A calculates the similarity by comparing the driving characteristic vector that is the passenger characteristic information with each of the driving characteristic vectors that are the pieces of driving characteristic information. The vehicle dispatch management unit 58A determines a predetermined number of pieces of driving characteristic information in ascending order of the calculated similarity as driving characteristic information similar to the passenger characteristic information. In other words, the vehicle dispatch management unit 58A determines the vehicle 2 of the driver D having driving characteristic information similar to the passenger characteristic information of the requester R as the vehicle 2 which is a candidate for vehicle dispatch. The vehicle dispatch management unit 58A outputs the dispatched vehicle information 64 related to the driver D of the specified driving characteristic information to the requester terminal 20.

The vehicle dispatch management unit 58A outputs, to the requester terminal 20, the dispatched vehicle information 64 regarding the driver D of the driving characteristic information similar to the passenger characteristic information representing the driving characteristics preferred by the requester R, which is identified by the requester ID included in the vehicle dispatch request information acquired from the requester terminal 20. By this output processing, the vehicle dispatch management unit 58A displays the dispatched vehicle information 64 preferred by the requester R on the display screen 61 of the display unit 16A of the requester terminal 20.

Thus, the display screen 61 such as the display screen 62 illustrated in FIG. 5A and the display screen 66 illustrated in FIG. 5B is displayed on the display unit 16A of the requester terminal 20.

When the dispatched vehicle information 64 of the driver D who is to be requested to dispatch a vehicle is selected by the requester R, the vehicle dispatch management unit 58A acquires the driver ID included in the selected dispatched vehicle information 64 from the requester terminal 20. The vehicle dispatch management unit 58A determines the vehicle 2 of the driver D identified by the acquired driver ID as the vehicle 2 to be dispatched. The vehicle dispatch management unit 58A transmits vehicle dispatch request information to the in-vehicle system 10 of the specified vehicle 2. Thus, the vehicle dispatch request information is transmitted to the driver D having driving characteristics similar to the passenger characteristic information representing the driving characteristics preferred by the requester R.

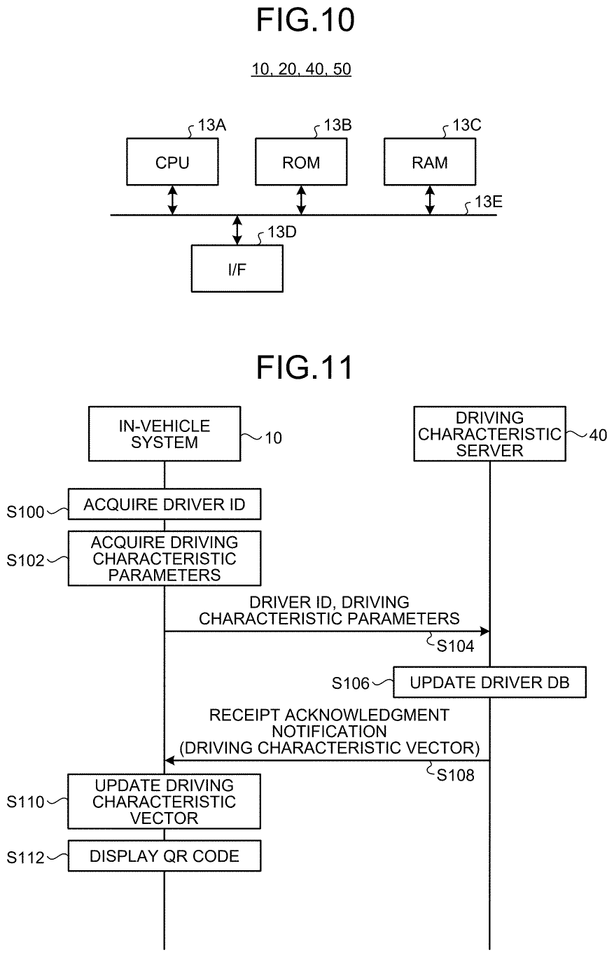

FIG. 10 is a hardware configuration diagram of an example of the in-vehicle system 10, the requester terminal 20, the driving characteristic server 40, and the matching server 50.

The in-vehicle system 10, the requester terminal 20, the driving characteristic server 40, and the matching server 50 each have a hardware configuration using a normal computer in which a central processing unit (CPU) 13A, a read only memory (ROM) 13B, a random access memory (RAM) 13C, an I/F 13D, and the like, are connected to each other over a bus 13E.

The CPU 13A is an arithmetic device which controls the in-vehicle system 10, the requester terminal 20, the driving characteristic server 40, and the matching server 50 of the present embodiment. The ROM 13B stores programs, and the like, for implementing various kinds of processing by the CPU 13A. The RAM 13C stores data necessary for various kinds of processing by the CPU 13A. The I/F 13D is an interface for transmitting and receiving data.

A program for executing information processing to be executed by the in-vehicle system 10, the requester terminal 20, the driving characteristic server 40, and the matching server 50 of the present embodiment is provided by being incorporated in advance in the ROM 13B, or the like. Note that the program to be executed by the in-vehicle system 10, the requester terminal 20, the driving characteristic server 40, and the matching server 50 according to the present embodiment may be provided by being recorded in a computer-readable recording medium such as a CD-ROM, a flexible disk (FD), a CD-R, or a digital versatile disk (DVD) as a file in a format that can be installed or executed in the in-vehicle system 10, the requester terminal 20, the matching server 50, and the matching server 50.

Next, flow of information processing to be executed in the vehicle dispatch system 1 of the present embodiment will be described.

First, an example of flow of information processing regarding generation of driving characteristic information of the driver D will be described.

FIG. 11 is a sequence diagram of an example of generation of driving characteristic information in the vehicle dispatch system 1.

The driving characteristic processing unit 11A of the in-vehicle system 10 acquires the driver ID of the driver D (Step S100). The driving characteristic processing unit 11A of the in-vehicle system 10 acquires the driving characteristic parameters of the driver D (Step S102). The driving characteristic processing unit 11A acquires the driving characteristic parameters by acquiring measurement results respectively from the G sensor 12, the steering angle sensor 13, the travel control unit 14, and the IVI apparatus 16.

The driving characteristic processing unit 11A of the in-vehicle system 10 transmits the driving characteristic parameters of respective items representing the driving characteristics such as the acceleration in the forward-back direction, the lateral G, the jerk, the type of the selected road, and the degree of overspeed, and the driver ID to the driving characteristic server 40 (Step S104). Note that the driving characteristic processing unit 11A may transmit the QR code representing the driver ID and the driving characteristic parameters to the driving characteristic server 40.

The driving characteristic management unit 48A of the driving characteristic server 40 updates the driver DB 44A by using the driver ID and the driving characteristic parameters acquired in Step S104 (Step S106). The driving characteristic management unit 48A generates a driving characteristic vector representing an average value for each item by using the driving characteristic parameters corresponding to multiple times, corresponding to the acquired driver ID and the driving characteristic parameters newly acquired in Step S104. The driving characteristic management unit 48A registers the generated driving characteristic vector in the driver DB 44A in association with the driver ID of the driving characteristic parameters used for generating the driving characteristic vector.

The driving characteristic management unit 48A of the driving characteristic server 40 transmits a receipt acknowledgement notification including the generated driving characteristic vector to the in-vehicle system 10 (Step S108).

The driving characteristic processing unit 11A of the in-vehicle system 10 stores the driving characteristic vector acquired from the in-vehicle system 10 in the storage unit 17 to update the driving characteristic vector (Step S110). Then, the driving characteristic processing unit 11A of the in-vehicle system 10 displays the QR code representing the driving characteristic vector updated in Step S110 on the display unit 16A (Step S112). The driving characteristic processing unit 11A may display the driving characteristic vector on the display unit 16A. By the display processing in Step S112, the driver D can understand his/her driving characteristics. In addition, by the display processing in Step S112, the driving characteristics of the driver D can be presented to the requester R who rides in the vehicle 2.

Next, an example of flow of information processing regarding generation of the passenger characteristic information of the requester R will be described.

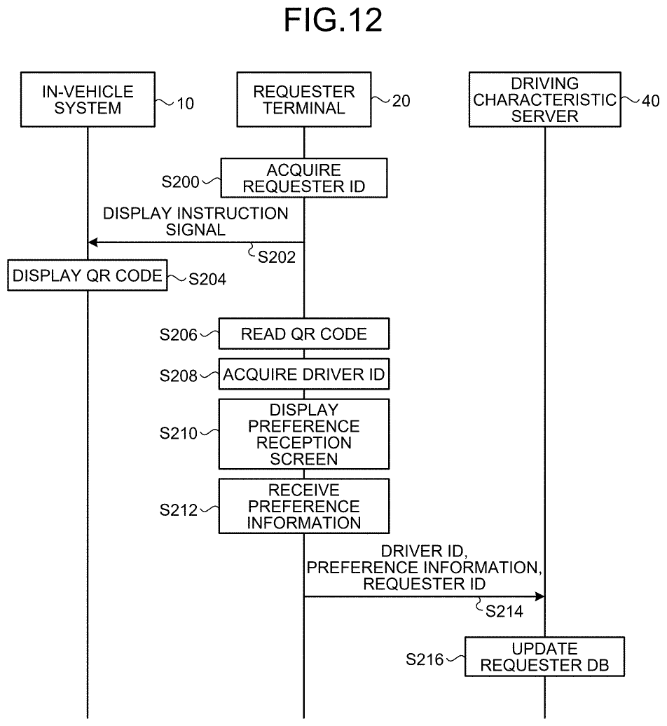

FIG. 12 is a sequence diagram of an example of generation of passenger characteristic information in the vehicle dispatch system 1.

The passenger characteristic processing unit 25A of the requester terminal 20 acquires the requester ID of the requester R (Step S200). For example, the passenger characteristic processing unit 25A acquires the requester ID by reading the requester ID from the storage unit 24.

Specifically, the passenger characteristic processing unit 25A of the requester terminal 20 transmits a display instruction signal of the driving characteristics to the in-vehicle system 10 of the vehicle 2 (Step S202). The driving characteristic processing unit 11A of the in-vehicle system 10 which has received the display instruction signal displays at least the QR code representing the driver ID on the display unit 16A (Step S204).

The requester R riding in the vehicle 2 causes the requester terminal 20 to read the QR code displayed on the display unit 16A of the vehicle 2 by using the imaging unit 21. The passenger characteristic processing unit 25A of the requester terminal 20 reads the QR code captured by the imaging unit 21 (Step S206). The passenger characteristic processing unit 25A of the requester terminal 20 acquires the driver ID represented by the QR code by analyzing the read QR code (Step S208). In a case where the QR code represents the driver ID and the driving characteristic vector of the driver D, the passenger characteristic processing unit 25A analyzes the QR code to acquire the driver ID and the driving characteristic vector represented by the QR code.

The passenger characteristic processing unit 25A of the requester terminal 20, which has read the QR code, displays a preference reception screen 60 on the UI unit 23 (Step S210). For example, the reception screen 60 illustrated in FIG. 4 is displayed on the UI unit 23.

The requester R inputs, via the reception screen 60, the degree of preference with respect to the driving characteristics of the driver D of the vehicle 2 in which the requester R rides. The passenger characteristic processing unit 25A of the requester terminal 20 receives preference information representing the input degree of preference (Step S212).

The passenger characteristic processing unit 25A of the requester terminal 20 transmits, to the driving characteristic server 40, the received preference information, the driver ID acquired in Step S208, and the requester ID of the requester R (Step S214).

The passenger characteristic management unit 48B of the driving characteristic server 40 updates the requester DB 44B by using the requester ID, the preference information, and the driver ID acquired from the requester terminal 20 (Step S216). The passenger characteristic management unit 48B generates the passenger characteristic information by correcting the driving characteristic information of the driver D of the vehicle 2, in which the requester R rides, with the preference information of the requester R for the driving characteristics of the driving characteristic information. Then, the passenger characteristic management unit 48B registers the passenger characteristic information in the passenger characteristic management unit 48B.

Thus, in the requester DB 44B, the passenger characteristic information obtained by correcting the driving characteristic information of the driver D of the vehicle 2 in which the requester R rides with the preference information representing a degree of preference of the requester R for the driving characteristics of the driver D is registered. The driving characteristic vector, which is the passenger characteristic information corresponding to the requester ID in the requester DB 44B, is updated every time that new preference information is acquired from the requester terminal 20.

Next, an example of flow of information processing regarding dispatch of the vehicle 2 will be described.

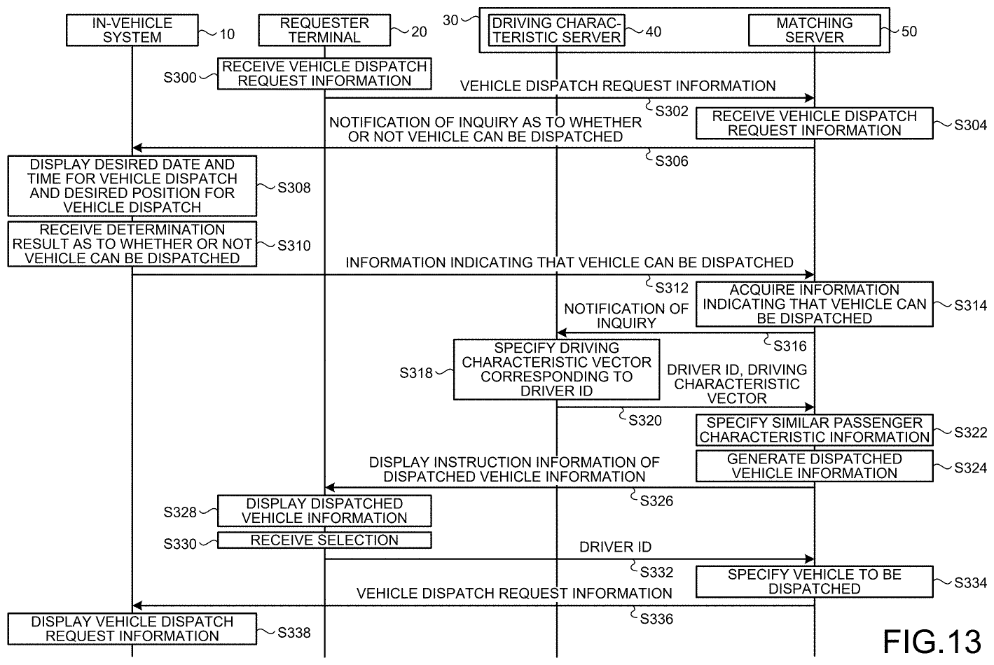

FIG. 13 is a sequence diagram of an example of dispatch of the vehicle 2 in the vehicle dispatch system 1.

The vehicle dispatch processing unit 25B of the requester terminal 20 receives an input of vehicle dispatch request information from the requester R (Step S300). The requester R inputs the vehicle dispatch request information by operating the UI unit 23. The vehicle dispatch request information includes at least the requester ID of the requester R. In the present embodiment, the vehicle dispatch request information includes the requester ID, information as to a desired date and time for vehicle dispatch, and information as to a desired location for vehicle dispatch.

The vehicle dispatch processing unit 25B of the requester terminal 20 transmits the vehicle dispatch request information received in Step S300 to the matching server 50 (Step S302).

Upon acquiring the vehicle dispatch request information (Step S304), the vehicle dispatch management unit 58A of the matching server 50 transmits a notification of an inquiry as to whether or not a vehicle can be dispatched (that is, the dispatch inquiry notification) to the in-vehicle system 10 of the driver D identified by the driver ID registered in the driver DB 44A (Step S306).

The vehicle dispatch processing unit 11B of the in-vehicle system 10 displays the dispatch inquiry notification received from the matching server 50 on the display unit 16A (Step S308). For example, the vehicle dispatch processing unit 11B displays, on the display unit 16A, the desired date and time for vehicle dispatch and the desired location for vehicle dispatch included in the dispatch inquiry notification (Step S308).

The driver D determines whether or not he/she can dispatch a vehicle while referring to the dispatch inquiry notification, and inputs the determination result via the display unit 16A. For example, it is assumed that driver D inputs information representing that he/she can dispatch a vehicle by operating the input unit 16B. The vehicle dispatch processing unit 11B of the in-vehicle system 10 receives a determination result as to whether or not a vehicle can be dispatched (Step S310). The description will be continued assuming that a determination result indicating that a vehicle can be dispatched is received.

The driving characteristic processing unit 11A of the in-vehicle system 10 transmits, to the matching server 50, the dispatch available information including the driver ID of the driver D who drives the vehicle 2 of the in-vehicle system 10, the determination result indicating that the vehicle can be dispatched, and the position information of the vehicle 2 (Step S312).

The vehicle dispatch management unit 58A of the matching server 50 acquires, from the in-vehicle system 10, the dispatch available information including the driver ID, the determination result indicating that a vehicle can be dispatched, and the position information of the vehicle 2 (Step S314). The description will be continued assuming that the vehicle dispatch management unit 58A acquires the dispatch available information from the plurality of in-vehicle systems 10.

The vehicle dispatch management unit 58A of the matching server 50 transmits the notification of the inquiry to the driving characteristic server 40 (Step S316). The notification of the inquiry includes the driver ID included in each of the pieces of dispatch available information received in Step S312. The notification of the inquiry includes the requester ID included in the vehicle dispatch request information received in Step S302. Further, the notification of the inquiry includes information representing a request for a driving characteristic vector.

The processing unit 48 of the driving characteristic server 40 specifies, from the driver DB 44A, driving characteristic vectors, which are driving characteristic information corresponding to the plurality of driver IDs included in the notification of the inquiry received in Step S316, (Step S318). In addition, the processing unit 48 of the driving characteristic server 40 specifies, from the requester DB 44B, a driving characteristic vector, which is passenger characteristic information corresponding to the requester ID included in the notification of the inquiry (Step S318). Then, the processing unit 48 of the driving characteristic server 40 transmits the specified driving characteristic vectors, which are the driving characteristic information corresponding to the plurality of driver IDs, and the driving characteristic vector, which is the passenger characteristic information corresponding to the requester ID, to the matching server 50 (Step S320).

The vehicle dispatch management unit 58A of the matching server 50 specifies, out of the pieces of driving characteristic information acquired in Step S320, driving characteristic information similar to the passenger characteristic information acquired in Step S320 (Step S322). In other words, the vehicle dispatch management unit 58A specifies, as vehicles being candidates for vehicle dispatch, the vehicles 2 (the vehicle 2x, the vehicle 2y, and the vehicle 2z) of the drivers D (for example, the driver Dx, the driver Dy, and the driver Dz) having driving characteristic information similar to the passenger characteristic information of the requester R. The vehicle dispatch management unit 58A of the matching server 50 generates the dispatched vehicle information 64 on each of the driver Dx, the driver Dy, and the driver Dz in the driving characteristic information specified in Step S322 (Step S324). Then, the vehicle dispatch management unit 58A of the matching server 50 outputs display instruction information representing a display instruction of the dispatched vehicle information 64 generated in Step S324 to the requester terminal 20 (Step S326).

The requester terminal 20 displays the display screen 61 of the dispatched vehicle information 64 on the UI unit 23 in response to the display instruction information received in Step S326 (Step S328). In other words, the display screen 61 of the dispatched vehicle information 64, such as the display screen 62 illustrated in FIG. 5A or the display screen 66 illustrated in FIG. 5B, is displayed on the UI unit 23 under the control of the vehicle dispatch management system 30.

The requester R selects the dispatched vehicle information 64 of the driver D who desires to dispatch the vehicle by operating the UI unit 23 while referring to the displayed display screen 61. For example, it is assumed that the requester R selects the dispatched vehicle information 64 of the driver Dy. The vehicle dispatch processing unit 25B of the requester terminal 20 receives selection of the dispatched vehicle information 64 (Step S330). The vehicle dispatch processing unit 25B of the requester terminal 20 transmits, to the matching server 50, IDy which is the driver ID included in the selected dispatched vehicle information 64 (Step S332).

The vehicle dispatch management unit 58A of the matching server 50 specifies, as the vehicle 2 to be dispatched, the vehicle 2y of the driver Dy identified by IDy being the driver ID acquired in Step S332 (Step S334). The vehicle dispatch management unit 58A of the matching server 50 transmits vehicle dispatch request information to the in-vehicle system 10 of the specified vehicle 2 (Step S336). Thus, the vehicle dispatch request information is transmitted to the driver Dy having driving characteristics similar to the passenger characteristic information representing the driving characteristics preferred by the requester R. The driving characteristic processing unit 11A of the in-vehicle system 10 displays the vehicle dispatch request information received in Step S336 on the display unit 16A (Step S338). The vehicle dispatch request information includes, for example, information representing that the vehicle has been determined as a vehicle to be dispatched, the information as to the desired location for vehicle dispatch, and the information as to desired date and time for vehicle dispatch. By checking the vehicle dispatch request information displayed on the display unit 16A, the driver D can understand that his/her vehicle is specified as the vehicle 2 to be dispatched and information regarding date and time and the location for vehicle dispatch.

In the present embodiment, a mode in which the vehicle dispatch management system 30 includes two information processing apparatuses of the driving characteristic server 40 and the matching server 50 has been described as an example. However, the driving characteristic server 40 and the matching server 50 may be constituted as one information processing apparatus. The vehicle dispatch management system 30 may include three or more information processing apparatuses.

As described above, the vehicle dispatch management system 30 of the present embodiment includes one or more information processing apparatuses and a recording device that records information for causing the one or more information processing apparatuses to execute operation. Specifically, the vehicle dispatch management system 30 of the present embodiment includes the driving characteristic server 40, the matching server 50, and the recording device. Specifically, the recording device is the ROM 13B, the storage unit 44, or the storage unit 54.

The vehicle dispatch management system 30 acquires vehicle dispatch request information including the requester ID of the requester R from the requester terminal 20 of the requester R who requests vehicle dispatch, which is connected over the network N. The vehicle dispatch management system 30 outputs, to the requester terminal 20, the dispatched vehicle information 64 regarding the driver D having the driving characteristic information similar to the passenger characteristic information representing the driving characteristics preferred by the requester R identified by the requester ID, thereby displaying the dispatched vehicle information 64 on the display screen 61 of the UI unit 23 provided in the requester terminal 20.

In this manner, the vehicle dispatch management system 30 the requester terminal 20 to display, on the display screen 61, the dispatched vehicle information 64 regarding the driver D having the driving characteristic information similar to the passenger characteristic information representing the driving characteristics preferred by the requester R, on the basis of the acquired vehicle dispatch request information.

By using the dispatched vehicle information 64 selected by the requester R from the display screen 61, the vehicle dispatch management system 30 can request the driver D having the driving characteristics according to the preference for driving of the requester R to dispatch the vehicle.

Thus, the vehicle dispatch management system 30 of the present embodiment can dispatch a vehicle in accordance with the preference for driving of the requester R.

The vehicle dispatch management system 30 of the present embodiment can be applied to various systems which dispatch the vehicle 2 to the requester R. For example, the vehicle dispatch management system 30 can be applied to a system related to ride-sharing, taxi, or limousine. The ride-sharing is a social service that matches the ridesharing demand of the vehicle 2. The taxi is a vehicle 2 for business use that carries the requester R to a destination in response to the request of the requester R. The limousine is a chartered vehicle 2 with a driver D that carries the requester R to a destination in response to the request of the requester R.

The vehicle dispatch management method and the vehicle dispatch management system according to the present disclosure are each capable of dispatching a vehicle in accordance with the requester's preference for driving.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A vehicle dispatch management method comprising:
acquiring, from a requester terminal of a requester who requests vehicle dispatch, vehicle dispatch request information including requester identification information of the requester; and
causing the requester terminal to display dispatched vehicle information onto a display screen of the requester terminal by outputting the dispatched vehicle information to the requester terminal, the dispatched vehicle information being information about a driver of driving characteristic information similar to passenger characteristic information, the passenger characteristic information representing driving characteristics preferred by the requester identified by the requester identification information.

2. The vehicle dispatch management method according to claim 1, wherein the dispatched vehicle information includes similarity information representing similarity of the driving characteristic information with respect to the passenger characteristic information.

3. The vehicle dispatch management method according to claim 2, wherein the causing includes causing the requester terminal to display, onto the display screen, pieces of the dispatched vehicle information arranged in order of the similarity.

4. The vehicle dispatch management method according to claim 3, wherein
the vehicle dispatch request information includes information as to a desired location for vehicle dispatch, and
the dispatched vehicle information includes estimated time information indicating time required for the vehicle of the driver to reach the desired location for vehicle dispatch.

5. The vehicle dispatch management method according to claim 4, wherein the causing includes causing the requester terminal to display, onto the display screen, pieces of the dispatched vehicle information arranged in order of the similarity and/or the required time.

6. The vehicle dispatch management method according to claim 4, wherein the dispatched vehicle information includes position information representing a position of the vehicle.

7. The vehicle dispatch management method according to claim 1, wherein the passenger characteristic information and the driving characteristic information each indicate at least one of pieces of information about a vehicle being traveling, the pieces of information including
acceleration in a traveling direction and in a direction opposite to the traveling direction,
acceleration in a direction intersecting the traveling direction,
jerk,
a type of a selected road, and
a degree of overspeed of vehicle speed with respect to a speed limit.

8. The vehicle dispatch management method according to claim 1, wherein the passenger characteristic information is information obtained by correcting the driving characteristic information of the driver of the vehicle, in which the requester rides, with preference information representing a degree of preference of the requester with respect to the driving characteristics of the driving characteristic information.

9. A vehicle dispatch management system comprising:
one or more information processing apparatuses; and
a recording device configured to record information for causing the one or more information processing apparatuses to execute operation,
wherein the one or more information processing apparatuses configured to
acquire, from a requester terminal of a requester who requests vehicle dispatch, vehicle dispatch request information including requester identification information of the requester, the requester terminal being connected to the one or more information processing apparatus over a network, and
cause the requester terminal to display dispatched vehicle information onto a display screen of the requester terminal by outputting the dispatched vehicle information to the requester terminal, the dispatched vehicle information being information about a driver of driving characteristic information similar to passenger characteristic information, the passenger characteristic information representing driving characteristics preferred by the requester identified by the requester identification information.
